(19) United States
(12) Patent Application Publication
(10) Pub. No.: US 2025/0386016 A1
(43) Pub. Date: Dec. 18, 2025

(54) SIGNALING BY USING TEMPLATE MATCHING COST

(71) Applicant: Tencent America LLC, Palo Alto, CA (US)

(72) Inventors: Lien-fei CHEN, Palo Alto, CA (US); Xin ZHAO, San Jose, CA (US); Madhu PERINGASSERY KRISHNAN, Mountain View, CA (US); Biao WANG, San Jose, CA (US); Roman CHERNYAK, Santa Clara, CA (US); Shan LIU, San Jose, CA (US)

(73) Assignee: Tencent America LLC, Palo Alto, CA (US)

(21) Appl. No.: 19/249,821

(22) Filed: Jun. 25, 2025

Related U.S. Application Data
(63) Continuation of application No. PCT/US2024/031235, filed on May 28, 2024.
(60) Provisional application No. 63/526,960, filed on Jul. 14, 2023.

(51) Int. Cl. H04N 19/117; H04N 19/159; H04N 19/176; H04N 19/196

(52) U.S. Cl. CPC H04N 19/117; H04N 19/159; H04N 19/176; H04N 19/198

(57) ABSTRACT

An apparatus including processing circuitry is provided. The processing circuitry is configured to, when a first syntax element indicates that a non-linear function-based prediction method is applied to reconstruct a current block, determine a prediction model from a plurality of candidate prediction models based on a plurality of TM costs between a template of the current block and a template of a reference block according to the plurality of candidate prediction models associated with the non-linear function-based prediction method. The processing circuitry is configured to determine a prediction block of the current block as the reference block processed by a non-linear function of the prediction model.

### INCORPORATION BY REFERENCE

The present application is a continuation of International Application No. PCT/US2024/031235, filed on May 28, 2024, which claims the benefit of priority to U.S. Provisional Application No. 63/526,960, “ON IMPROVEMENT OF SIGNALING BY USING TEMPLATE MATCHING COST” filed on Jul. 14, 2023. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of processing visual media data is provided. In the method, a bitstream of the visual media data is processed according to a format rule. In an example, the bitstream includes a first syntax element that indicates whether a non-linear function-based prediction method is applied to process a current block based on a template matching prediction. The non-linear function-based prediction method applies a prediction model that is associated with a template type of a template of the current block and includes a non-linear function. The non-linear function is applied to a reference block of the current block. The non-linear function includes parameters derived based on the template of the current block and a template of the reference block. The format rule specifies that, when the first syntax element indicates that the non-linear function-based prediction method is applied to the current block, a plurality of template matching (TM) costs between the template of the current block and the template of the reference block is determined according to a plurality of candidate prediction models associated with the non-linear function-based prediction method. The format rule specifies that the prediction model is determined from the plurality of candidate prediction models based on the plurality of TM costs. For example, the prediction model corresponds to a selected TM cost of the plurality of TM costs. The format rule specifies that the non-linear function of the prediction model is applied to process samples of the reference block. The format rule specifies that a prediction block of the current block is determined as the processed reference block by the non-linear function of the prediction model.

In an example, the format rule specifies that a function of each of the plurality of candidate prediction models is applied to the template of the current block and the template of the reference block to obtain a processed template of the current block and the processed template of the reference block. The format rule specifies that each of the plurality of TM costs is determined based on the processed template of the current block and the processed template of the reference block according to a respective one of the candidate prediction models. The format rule specifies that the prediction model is determined from the plurality of candidate prediction models that corresponds to a minimum TM cost of the plurality of TM costs.

In an example, the format rule specifies that processed samples of the template of the current block and processed samples of the template of the current block are generated based on a first candidate prediction model of the plurality of candidate prediction models. The format rule specifies that a first TM cost of the plurality of TM costs is determined based on the processed samples of the template of the current block and the processed samples of the template of the reference block. The format rule specifies that the samples of the template of the current block and the samples of the template of the reference block are filtered. The format rule specifies that processed filtered samples of the template of the current block and processed filtered samples of the template of the current block are generated based on the first candidate prediction model. The format rule specifies that a second TM cost of the plurality of TM costs is determined based on the processed filtered samples of the template of the current block and the processed filtered samples of the template of the reference block.

According to another aspect of the disclosure, a method of video encoding is provided. In the method, a reference block of a current block is determined based on a template of the current block and a template of the reference block according to an intra template matching prediction (intraTMP). A prediction model is determined from a plurality of candidate prediction models based on a plurality of TM costs between the template of the current block and the template of the reference block according to the plurality of candidate prediction models. The prediction model is associated with a template type of the template of the current block and includes a function that is applied to the reference block of the current block. The function includes parameters derived based on the template of the current block and the template of the reference block. A prediction block of the current block is determined based on the prediction model. The current block is encoded based on the determined prediction block into a bitstream and a syntax element is encoded into the bitstream. The syntax element indicates whether a function-based prediction method that includes the prediction model is applied to reconstruct the current block.

In an example, a function of each of the plurality of candidate prediction models is applied to the template of the current block and the template of the reference block to obtain a processed template of the current block and the processed template of the reference block. Each of the plurality of TM costs is determined based on the processed template of the current block and the processed template of the reference block according to the respective candidate prediction model. The prediction model is determined from the plurality of candidate prediction models that corresponds to a minimum TM cost of the plurality of TM costs.

In an example, processed samples of the template of the current block and processed samples of the template of the current block are generated based on a first candidate prediction model of the plurality of candidate prediction models. A first TM cost of the plurality of TM costs is determined based on the processed samples of the template of the current block and the processed samples of the template of the reference block. The samples of the template of the current block and the samples of the template of the reference block are filtered. Processed filtered samples of the template of the current block and processed filtered samples of the template of the current block are generated based on the first candidate prediction model. A second TM cost of the plurality of TM costs is determined based on the processed filtered samples of the template of the current block and the processed filtered samples of the template of the reference block.

According to yet another aspect of the disclosure, an apparatus of video decoding is provided. The apparatus includes processing circuitry. The processing circuitry is configured to receive a bitstream including a first syntax element that indicates whether a function-based prediction method is applied to reconstruct a current block based on a template matching prediction. The function-based prediction method applies a prediction model that is associated with a template type of a template of the current block and includes a function that is applied to a reference block of the current block. The function includes parameters that are derived based on the template of the current block and a template of the reference block. The processing circuitry is configured to, when the first syntax element indicates that the function-based prediction method is applied to reconstruct the current block, determine the prediction model from a plurality of candidate prediction models based on a plurality of TM costs between the template of the current block and a template of the reference block according to the plurality of candidate prediction models associated with the function-based prediction method. The processing circuitry is configured to determine a prediction block of the current block as the reference block processed by the function of the prediction model.

In an example, the processing circuitry is configured to apply a function of each of the plurality of candidate prediction models to the template of the current block and the template of the reference block to obtain a processed template of the current block and the processed template of the reference block. The processing circuitry is configured to determine each of the plurality of TM costs based on the processed template of the current block and the processed template of the reference block according to a respective one of the candidate prediction models. The processing circuitry is configured to determine the prediction model from the plurality of candidate prediction models that corresponds to a minimum TM cost of the plurality of TM costs.

In an example, the template type includes (i) a first template type that includes a first template region positioned at a left side of the current block, (ii) a second template type that includes a second template region positioned at a top side of the current block, (iii) a third template type including the first template region positioned at the left side of the current block and the second template region positioned at the top side of the current block, and (iv) a fourth temple type including the first template region positioned at the left side of the current block, the second template region positioned at the top side of the current block, and a top-left template region positioned at a top-left corner of the current block and arranged between the first template region and the second template region.

In an example, the processing circuitry is configured to generate processed samples of the template of the current block and processed samples of the template of the current block based on a first candidate prediction model of the plurality of candidate prediction models. The processing circuitry is configured to determine a first TM cost of the plurality of TM costs based on the processed samples of the template of the current block and the processed samples of the template of the reference block. The processing circuitry is configured to filter the samples of the template of the current block and the samples of the template of the reference block. The processing circuitry is configured to generate processed filtered samples of the template of the current block and processed filtered samples of the template of the current block based on the first candidate prediction model. The processing circuitry is configured to determine a second TM cost of the plurality of TM costs based on the processed filtered samples of the template of the current block and the processed filtered samples of the template of the reference block.

In an example, the processing circuitry is configured to subtract a mean of samples of the template of the current block from each of the samples of the template of the current block to generate adjusted samples of the template of the current block. The processing circuitry is configured to subtract a mean of samples of the template of the reference block from each of the samples of the template of the reference block to generated adjust samples of the template of the current block. The processing circuitry is configured to determine a third TM cost of the plurality of TM costs based on the adjusted samples of the template of the current block and the adjusted samples of the template of the reference block.

In an example, the processing circuitry is configured to determine a first TM cost of the plurality of TM costs based on samples of the template of the current block and samples of the template of the reference block. The processing circuitry is configured to generate processed samples of the template of the current block and processed samples of the template of the current block based on a first candidate prediction model of the plurality of candidate prediction models. The processing circuitry is configured to determine a second TM cost of the plurality of TM costs based on the processed samples of the template of the current block and the processed samples of the template of the reference block.

In an example, the processing circuitry is configured to determine one of the plurality of TM costs that is indicated by a second syntax element in the bitstream. The processing circuitry is configured to determine the prediction model from the plurality of candidate prediction models that corresponds to the determined one of the plurality of TM costs. The processing circuitry is configured to apply the function of the prediction model to process samples of the reference block. The processing circuitry is configured to determine the prediction block of the current block based on the samples of the reference block that are processed by the function of the prediction model.

In an example, the processing circuitry is configured to normalize each TM cost of the plurality of TM costs by dividing the respective TM cost with a template size corresponding to the respective TM cost. The processing circuitry is configured to reorder the plurality of normalized TM costs in an ascending order based on the normalized TM costs. The processing circuitry is configured to generate a candidate list based on the plurality of reordered normalized TM costs.

In an example, the processing circuitry is configured to receive a third syntax element in the bitstream that indicates which one of the plurality of reordered normalized TM costs is selected. The third syntax element is associated with at least one of a Cb component or a Cr component of the current block. The processing circuitry is configured to determine the prediction model from the plurality of candidate prediction models that corresponds to the TM cost indicted by the third syntax element.

Aspects of the disclosure also provide an apparatus for video encoding. The apparatus for video encoding includes processing circuitry configured to implement any of the described methods for video encoding.

Aspects of the disclosure also provide a method for video decoding. The method includes any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of an intra template matching prediction (IntraTMP) according to some aspects of the disclosure.

FIG. 5 is a schematic illustrations of different template types according to some aspects of the disclosure.

FIG. 6 shows a flow chart outlining a decoding process according to some aspects of the disclosure.

FIG. 7 shows a flow chart outlining an encoding process according to some aspects of the disclosure.

FIG. 8 is a schematic illustration of a computer system in accordance with an aspect.

### DETAILED DESCRIPTION

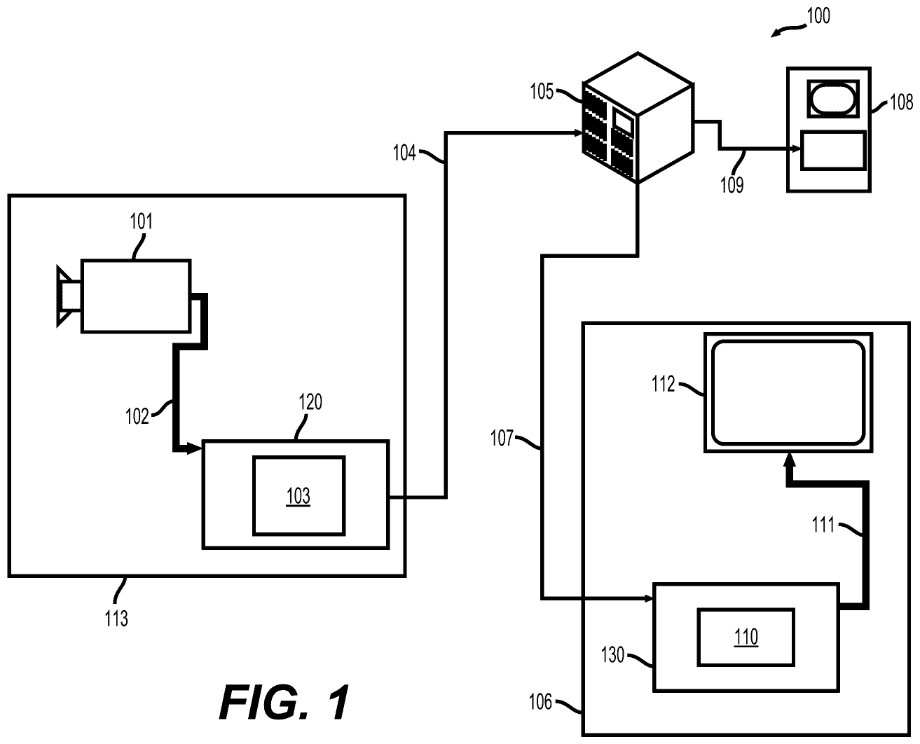

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

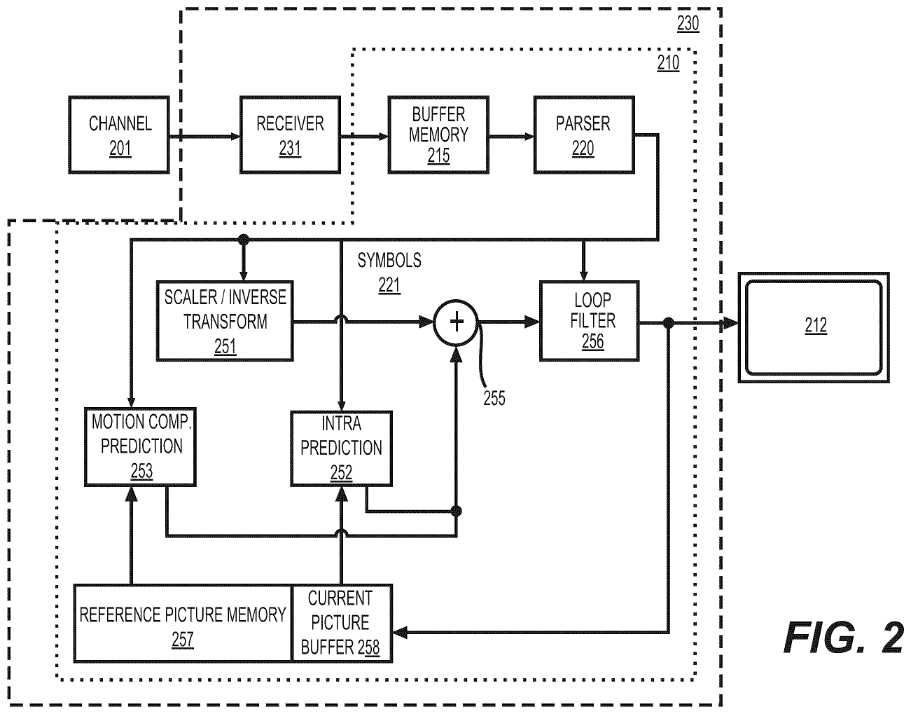

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

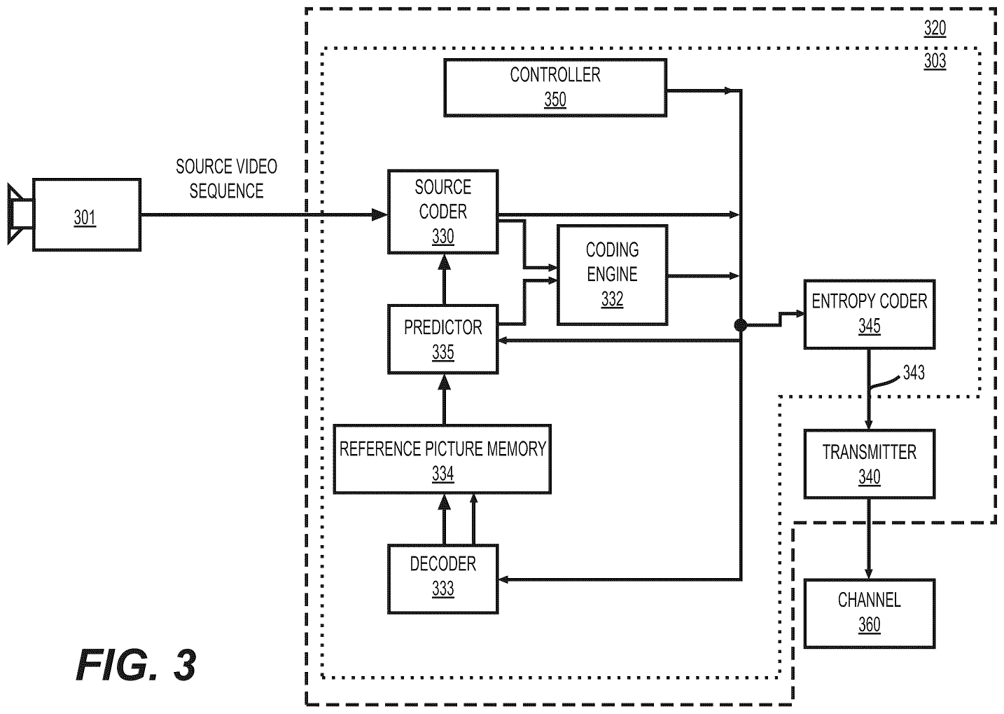

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure include techniques for improvement of signaling by using template matching cost.

Video coding has been widely used in many applications, such as broadcasting, video recording, and video streaming. Many emerging video coding standards, such H.264, H.265/HEVC, H.266/VVC, and AV1, are published and widely adopted in these video applications. In an aspect, a hybrid video codec may include various coding modules, such as an intra prediction, an inter prediction, a transform coding, a quantization, an entropy coding, and a post in-loop filter. In the disclosure, improvement of signaling by using a template matching cost is provided, for example to improve coding efficiency not only for an intra prediction but also for an inter prediction.

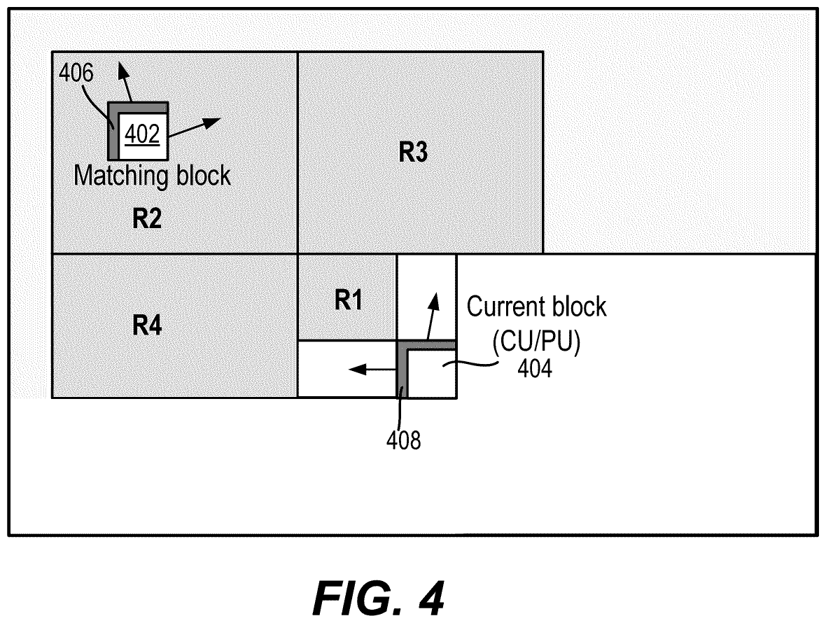

Intra template matching prediction (also referred to as intraTMP) is, for example, a special intra prediction mode that copies a best prediction block from the reconstructed part of the current frame, whose L-shaped template matches the current template (e.g., a template of a current block). For a predefined search range, the encoder may search for a most similar template to the current template in a reconstructed part of the current frame and uses the corresponding block as a prediction block, where the most similar template is associated with the corresponding block and the current template is associated with the current block. The encoder then signals the usage of the intraTMP mode, and the same prediction operation can be performed at a decoder side. A matching block (or corresponding block) (402) can be illustrated in FIG. 4 and act as the matching area for a current CU (404).

As shown in FIG. 4, the prediction signal may be generated by matching the L-shaped causal neighbors (or L-shaped template) of the current block (404) with another block in a predefined search area. An example predefined search area may include R1 (a current CTU), R2 (a top-left CTU), R3 (an above CTU), and R4 (a left CTU).

In an aspect, a sum of absolute differences (SAD) is used as a cost function in IntraTMP mode. Within each search area, the decoder can search for a template (406) of a block (402) that has a least SAD with respect to the current template (408) of the current block (404) and use the block with the least SAD as a corresponding block of the current block. The corresponding block may further act as a prediction block for the current block (404).

Dimensions of all search regions (e.g., SearchRange_w, SearchRange_h) may be set proportional to a block dimension (e.g., BlkW, BlkH) of the current block. Accordingly, a fixed number of SAD comparisons may be obtained in each pixel. For example, the dimensions of a search region (or search range) may be defined in Equations 1 and 2 as follows:

$$SearchRange\_w = a * BlkW \qquad Eq . ( 1 )$$

$$SearchRange\_h = a * BlkH \qquad Eq . ( 2 )$$

where “a” is a constant that controls a trade-off between a gain and a complexity of the search process. In an example, “a” is equal to 5.

In an aspect, to speed-up the template matching process, the search range of all search regions may be subsampled by a factor of 2. The reduced search range may lead to a reduction of template matching search by 4. After a best match is found, a refinement process may be further performed. The refinement may be performed via a second template matching search around the best match with a reduced range. The reduced range may be defined as min(BlkW, BlkH)/2.

The Intra template matching tool may be enabled for CUs with a size less than or equal to 64 in a width and a height. A maximum CU size for Intra template matching may be configurable.

In an aspect, the intra template matching prediction mode may signaled at a CU level through a dedicated flag when decoder-side intra mode derivation (DIMD) is not used for a current CU.

In an aspect, proposed methods of the disclosure may be used in any existing codecs mentioned above, such as H.264, H.265/HEVC, H.266/VVC, and AV1.

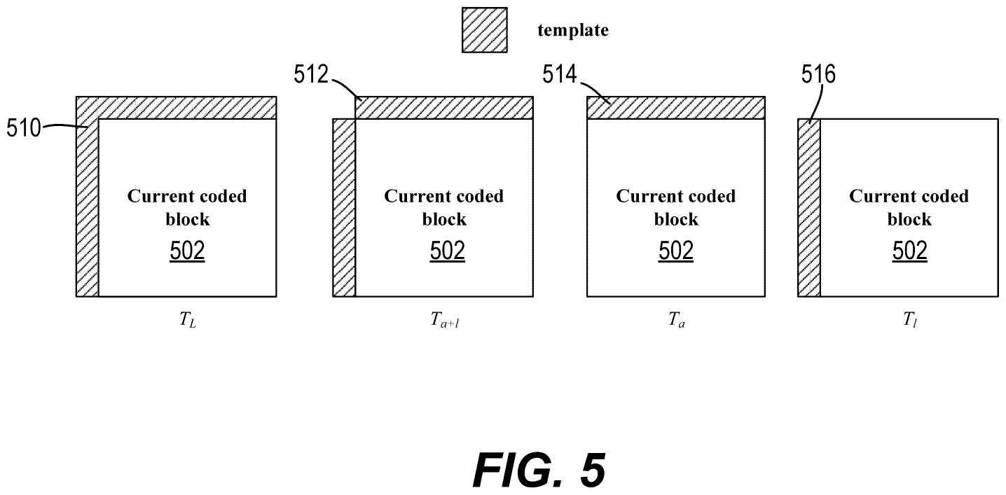

In the disclosure, a template of a coded block (or a current template) may include spatial neighboring reconstructed samples of the coded block. The template may be, but is not limited to, one of the template types shown in FIG. 5. A size of the template can be, but is not limited to, W×n or n×H, where W and H are a block width and a block height of the coded block, and the n is a non-zero positive integer value.

As shown in FIG. 5, various templates (or template types) of a current coded block (502) are provided. For example, the current coded block (502) can include a first template (or template type) (510) denoted as T_{L}, a second template (or template type) (512) denoted as Tₐ₊₁, a third template (or template type) (514) denoted as Tₐ, and a fourth template (or template type) (516) denoted as Ti. As shown in FIG. 5, the fourth template type (516) may include a template region positioned at a left side of the current block. The third template type (514) may include a template region positioned at a top side of the current block. The second template type (512) may include a first template region positioned at the left side of the current block and a second template region positioned at the top side of the current block. The first temple type (510) may include a first region positioned at the left side of the current block, a second region positioned at the top side of the current block, and a top-left region positioned at a top-left corner of the current block and arranged between the first region and the second region.

The template matching process may include several different processes. For example, the template matching process may include a searching process to find a most similar template (or reference template) to the current template in a reconstructed part of a current frame or reference frames. The template matching process may also include a matching process to calculate a distortion between the current template of the current block and a reference template of a prediction block in the reconstructed part of the current frame or the reference frames, and the reference template may be pointed to by a given motion vector (MV) on a reference picture or a block vector (BV) on the reconstructed part of the current frame.

In an aspect of the disclosure, a template matching process may use a filtered and/or an unfiltered template. For example, the template matching process may use a filtered current template and filtered candidate reference templates during the template matching process. In an example, the template matching process may use an unfiltered current template and unfiltered candidate reference templates during the template matching process. A similarity may be measured using a cost function that operates on the filtered/unfiltered templates. The cost function may include a sum of absolute difference (SAD), a mean absolute difference (MAD), a mean square error (MSE), and a sum of absolute transformed difference (SATD), and/or the like.

In an aspect, a first method (or function-based prediction method) of an intra or an inter prediction improvement is provided to reduce, or minimize, a distortion between a current block and a prediction block of the current block from a corresponding reference picture by applying a non-linear function or a linear function using the original prediction block as input. The non-linear or the linear function may be defined by a non-linear formula or linear formula, respectively. In an example, the linear function is defined as

$${\sum }_{i = 0}^{n} ( {α}_{i} \times p ( {x}_{i} , {y}_{i} ) ) + β ,$$

where n is a non-negative number, and p(xᵢ,yᵢ) is a predicted sample pointed to by MV at a location (xᵢ,yᵢ) on the reference picture. Thus, p(xᵢ,yᵢ), when i=0, . . . , n, may indicate a group of samples around the sample located (or indicated) by the MV and indicate a prediction block of the current block. The parameters αᵢ and β may be derived based on a template of the current block and a template of the prediction block (e.g., by using the least square method). In an example, the non-linear function may be defined as

$${\sum }_{i = 0}^{n} ( {α}_{i} \times {p ( {x}_{i} , {y}_{i} )}^{m} ) + β ,$$

where m is a positive integer, such as 2 or 3.

The above template-based method may also be used for an intra prediction. In the case of intra prediction, a MV may be replaced by a BV to indicate a position of reconstructed reference samples within the reference picture, and the BV may be derived by using a template-matching searching process or may be signaled in a bitstream. The parameters αᵢ and β may still be derived by templates of the current block and the prediction block.

In an aspect, a first syntax or first coded information, such as a control flag of the first method, is signaled in the bitstream (e.g., at a block level) to indicate whether the first method is applied on the current block or not. Alternatively, a value of the control flag may also be inferred or inherited from another coded block. In an example, the control flag of the first method associated with the current block is controlled by the control flag of the first method associated with one or more coded blocks. Moreover, the control flag may be derived at the coding block level to adaptively determine whether the first method is applied or not.

In an aspect, a second syntax or second coded information is signaled in the bitstream (e.g., at the block level) to indicate which template type is selected. For example, the second syntax indicates which one of the template types in FIG. 5 is selected.

In an aspect, several prediction models are applied to improve the prediction block. For example, a first model is derived based on a linear prediction function by using one template type and/or one template size and a second model is derived based on another nonlinear or another linear function by using a same template type and/or a same template size or another template type and/or another template size. A third syntax or third coded information may be signaled to select one of the prediction models. For example, the third syntax element indicates which one of the first model and second model is selected.

In an aspect, a prediction model refers to a prediction model that uses a non-linear function or a linear function.

In an aspect, a first syntax element or coded information, such as a flag, is signaled to indicate a decision whether the first method is applied or not. The decision may be determined based on a plurality of template costs, such as two different template matching costs. When the flag (or first syntax element) is true, it indicates that the method (or first method) with a smallest cost is selected. For example, two different template matching costs are determined based on a first distortion between a current template (or a template of a current block) and a reference template (or a template of a reference block) for a first model and a second distortion between the current template and the reference template for a second model. One of the first model and the second model is selected that corresponds to a smallest cost. Further, a function of the selected one of the first and second models may be applied to the reference block to determine a prediction block of the current block. For example, samples of the prediction block of the current block may be defined as samples of the reference block that are processed by the function of the selected model as

$${\sum }_{i = 0}^{n} ( {α}_{i} \times {p ( {x}_{i} , {y}_{i} )}^{m} ) + β ,$$

where p(xᵢ,yᵢ) are samples of the reference block.

The first syntax element or coded information, such as the flag, may apply to one or more color components. In an example, the flag (or first syntax element) is used for all color components (e.g., Cb component and Cr component) of a block.

In an example, each of the color components has a respective flag.

In an example, the flag (or first syntax element) may only be used for at least one specific color component of the color components of the block.

In an example, one cost is a distortion between a current template and a reference template for a specified model and another cost is a distortion between a filtered current template and a filtered reference template using the same model. The specified model may be defined by one or more of a linear prediction function or a non-linear prediction function, a template type and/or, a template size. In an example, the filtered current template and the filtered reference template are obtained by filtering the current reference template and the reference templated based on a filter. The filter may include a smooth filter, a low-pass filter, or any/or other suitable filters.

In an example, one cost is a distortion between a current template and a reference template, and another cost is a distortion between the current template with a mean removal and the reference template with a mean removal. For example, samples values of samples of the current template are subtracted by a mean value of the sample values of the current template. Sample values of samples of the reference template are subtracted by a mean value of the sample values of the reference template.

In an example, a cost is a normalized cost. The normalized cost may be derived from a distortion divided by normalization value, such as a template size. For example, a distortion between a current template and a reference template is obtained first. A normalized cost is derived by dividing the distortion with a template size of the current template.

In an example, distortions of all color components are measured when the first syntax element (or the flag) is used (or applied) for all color components. The first syntax element or the flag may indicate that the first method is applied to all the color components.

In an example, a distortion of at least one specific color component is measured when the first syntax element (or the flag) is used for all color components.

In an 1example, one cost is a distortion between a current template and a reference template without applying a linear model or a non-linear model (e.g., using a pure/original prediction signal p(xᵢ,yᵢ)) and another cost is a distortion between the current template and the reference template with applying a specific predefined model.

In an example, one cost is a distortion between a current template and a reference template by applying a first predefined linear or a first non-linear model and another cost is a distortion between the current template and the reference template by applying a second predefined linear or a second predefined non-liner model.

In an aspect, a second syntax element or coded information, such as a flag, is signaled to indicate a decision to decide which prediction model from a plurality of models (e.g., the first and second models described above) in the first method is selected. The decision may be determined based on template matching costs of the plurality of models, such as two different template matching costs of the first and second models that are described above. Each template matching cost may be determined based on a respective model that is applied to a current template and a reference template. When the flag (or second syntax element) is true, it may indicate that a model with a smallest cost is selected from the plurality of models.

In an example, the first model is derived based on a linear prediction function/a non-linear prediction function by using one template type and/or one template size and the second model is derived based on another nonlinear prediction function/another linear prediction function by using a same template type and/or a same template size or another template type and/or another template size. Two template matching costs are calculated based on a first distortion between the current template and the reference template under the first model, and a second distortion between the current template and the reference template under the second model.

In another example, the current template is divided into a first group and a second group, and the first model is applied to the first group and the second model is applied to the second group. Accordingly, the reference template may be divided into a first group and a second group, and first model may be applied to the first group and the second model may be applied to the second group. Two template matching costs may be calculated based on a first distortion between the first group of the current template and the first group of the reference template, and a second distortion between the second group of the current template and the second group of the reference template.

In an aspect, one option from a list of multiple options is selected by using template-matching costs of the multiple options. Each option may correspond to a respective template-matching cost based on a respective model. In an example, a syntax element (or third syntax element) or coded information, such as an index i, is signaled. The index i may indicate an ith candidate in the list of multiple options. The list may be constructed based on a template-matching cost of each option in an ascending order. A list size may be equal to a number of the multiple options.

In an example, the syntax element (or third syntax element) is used (or applied) for all color components.

In an example, each color component has a respective syntax element.

In an example, the syntax element (or third syntax element) may only be used for one or more specific color components. For example, the syntax element is used for at least one specific color component.

In an example, the multiple options include, but are not limited to, models of the first method. In an example, the first method with the first model is applied and the first method with the second model is applied.

In an example, the template-matching cost is a normalized cost. The normalized cost may be derived from a distortion divided by a normalization value, such as a template size.

In an example, distortions of all color components are measured when the syntax element (or third syntax element) is used for all color components.

In an example, a distortion of at least one specific color component is measured when the syntax element (or third syntax element) is used for all color components.

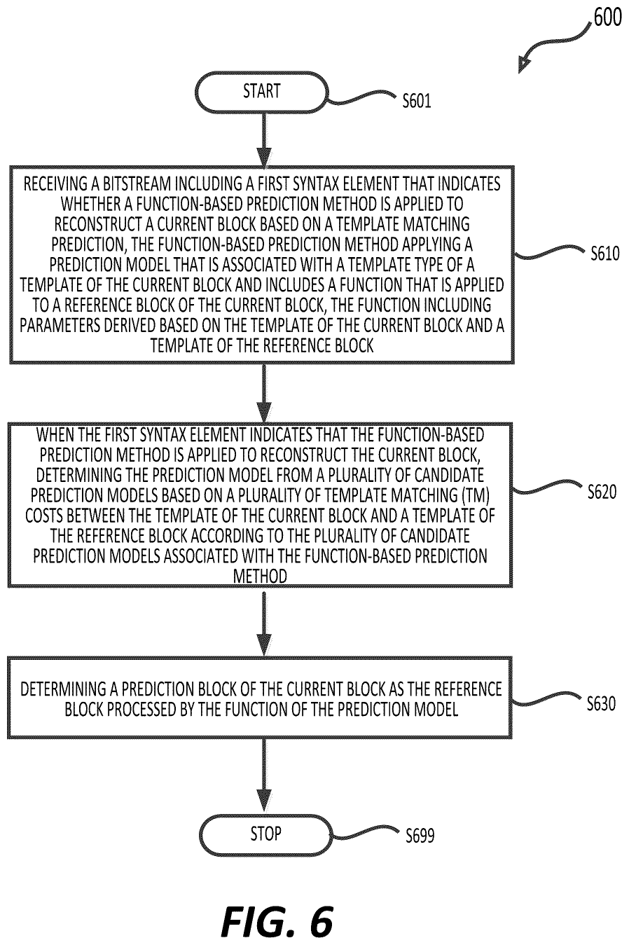

FIG. 6 shows a flow chart outlining a process (600) according to an aspect of the disclosure. The process (600) can be used in a video decoder. In various aspects, the process (600) is executed by processing circuitry, such as the processing circuitry that performs functions of the video decoder (110), the processing circuitry that performs functions of the video decoder (210), and the like. In some aspects, the process (600) is implemented in software instructions, thus when the processing circuitry executes the software instructions, the processing circuitry performs the process (600). The process starts at (S601) and proceeds to (S610).

At (S610), a bitstream is received. The bitstream includes a first syntax element that indicates whether a function-based prediction method is applied to reconstruct a current block based on a template matching prediction. The function-based prediction method applies a prediction model that is associated with a template type of a template of the current block and includes a function that is applied to a reference block of the current block. The function includes parameters derived based on the template of the current block and a template of the reference block.

At (S620), when the first syntax element indicates that the function-based prediction method is applied to reconstruct the current block, the prediction model is determined from a plurality of candidate prediction models based on a plurality of TM costs between the template of the current block and a template of the reference block according to the plurality of candidate prediction models associated with the function-based prediction method.

At (S630), a prediction block of the current block is determined as the reference block that is processed by the function of the prediction model.

In an example, a function of each of the plurality of candidate prediction models is applied to the template of the current block and the template of the reference block to obtain a processed template of the current block and the processed template of the reference block. Each of the plurality of TM costs is determined based on the processed template of the current block and the processed template of the reference block of the respective candidate prediction model. The prediction model is determined from the plurality of candidate prediction models that corresponds to a minimum TM cost of the plurality of TM costs.

In an example, the template type includes (i) a first template type that includes a first template region positioned at a left side of the current block, (ii) a second template type that includes a second template region positioned at a top side of the current block, (iii) a third template type including the first template region positioned at the left side of the current block and the second template region positioned at the top side of the current block, and (iv) a fourth temple type including the first template region positioned at the left side of the current block, the second template region positioned at the top side of the current block, and a top-left template region positioned at a top-left corner of the current block and arranged between the first template region and the second template region.

In an example, processed samples of the template of the current block and processed samples of the template of the current block are generated based on a first candidate prediction model of the plurality of candidate prediction models. A first TM cost of the plurality of TM costs is determined based on the processed samples of the template of the current block and the processed samples of the template of the reference block. The samples of the template of the current block and the samples of the template of the reference block are filtered. Processed filtered samples of the template of the current block and processed filtered samples of the template of the current block are generated based on the first candidate prediction model. A second TM cost of the plurality of TM costs is determined based on the processed filtered samples of the template of the current block and the processed filtered samples of the template of the reference block.

In an example, a mean of samples of the template of the current block is subtracted from each of the samples of the template of the current block to generate adjusted samples of the template of the current block. A mean of samples of the template of the reference block is subtracted from each of the samples of the template of the reference block to generated adjust samples of the template of the current block. A third TM cost of the plurality of TM costs is determined based on the adjusted samples of the template of the current block and the adjusted samples of the template of the reference block.

In an example, a first TM cost of the plurality of TM costs is determined based on samples of the template of the current block and samples of the template of the reference block. Processed samples of the template of the current block and processed samples of the template of the current block are generated based on a first candidate prediction model of the plurality of candidate prediction models. A second TM cost of the plurality of TM costs is determined based on the processed samples of the template of the current block and the processed samples of the template of the reference block.

In an example, one of the plurality of TM costs is determined. The one of the plurality of TM costs is indicated by a second syntax element in the bitstream. The prediction model is determined from the plurality of candidate prediction models that corresponds to the determined one of the plurality of TM costs. The function of the prediction model is applied to process samples of the reference block. The prediction block of the current block is determined based on the samples of the reference block that are processed by the function of the prediction model.

In an example, each TM cost of the plurality of TM costs is normalized by dividing the respective TM cost with a template size corresponding to the respective TM cost. The plurality of normalized TM costs is reordered in an ascending order based on the normalized TM costs. A candidate list is generated based on the plurality of reordered normalized TM costs.

In an example, a third syntax element is received in the bitstream that indicates which one of the plurality of reordered normalized TM costs is selected. The third syntax element is associated with at least one of a Cb component or a Cr component of the current block. The prediction model is determined from the plurality of candidate prediction models that corresponds to the TM cost indicted by the third syntax element.

Then, the process proceeds to (S699) and terminates.

The process (600) can be suitably adapted. Step(s) in the process (600) can be modified and/or omitted. Additional step(s) can be added. Any suitable order of implementation can be used.

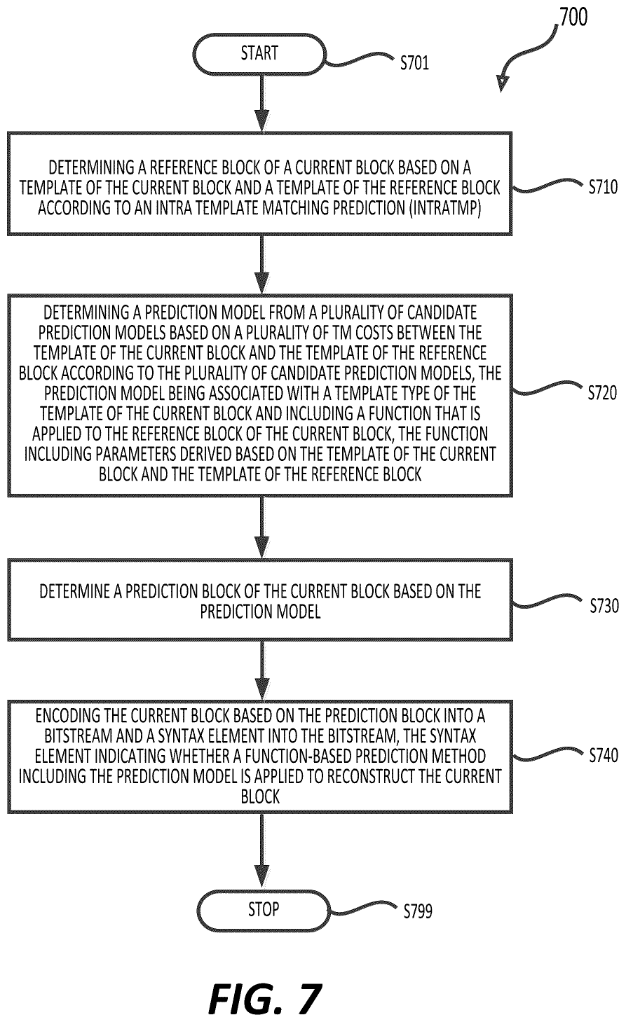

FIG. 7 shows a flow chart outlining a process (700) according to an aspect of the disclosure. The process (700) can be used in a video encoder. In various aspects, the process (700) is executed by processing circuitry, such as the processing circuitry that performs functions of the video encoder (103), the processing circuitry that performs functions of the video encoder (303), and the like. In some aspects, the process (700) is implemented in software instructions, thus when the processing circuitry executes the software instructions, the processing circuitry performs the process (700). The process starts at (S701) and proceeds to (S710).

At (S710), a reference block of a current block is determined based on a template of the current block and a template of the reference block according to an intraTMP.

At (S720), a prediction model is determined from a plurality of candidate prediction models based on a plurality of TM costs between the template of the current block and the template of the reference block according to the plurality of candidate prediction models. The prediction model is associated with a template type of the template of the current block and includes a function that is applied to the reference block of the current block. The function includes parameters derived based on the template of the current block and the template of the reference block.

At (S730), a prediction block of the current block is determined based on the prediction model.

At (S740), the current block is encoded based on the prediction block into a bitstream and a syntax element is encoded into the bitstream. The syntax element indicates whether a function-based prediction method that includes the prediction model is applied to reconstruct the current block.

In an example, a function of each of the plurality of candidate prediction models is applied to the template of the current block and the template of the reference block to obtain a processed template of the current block and the processed template of the reference block. Each of the plurality of TM costs is determined based on the processed template of the current block and the processed template of the reference block according to the respective candidate prediction model. The prediction model is determined from the plurality of candidate prediction models that corresponds to a minimum TM cost of the plurality of TM costs.

In an example, processed samples of the template of the current block and processed samples of the template of the current block are generated based on a first candidate prediction model of the plurality of candidate prediction models. A first TM cost of the plurality of TM costs is determined based on the processed samples of the template of the current block and the processed samples of the template of the reference block. The samples of the template of the current block and the samples of the template of the reference block are filtered. Processed filtered samples of the template of the current block and processed filtered samples of the template of the current block are generated based on the first candidate prediction model. A second TM cost of the plurality of TM costs is determined based on the processed filtered samples of the template of the current block and the processed filtered samples of the template of the reference block.

Then, the process proceeds to (S799) and terminates.

The process (700) can be suitably adapted. Step(s) in the process (700) can be modified and/or omitted. Additional step(s) can be added. Any suitable order of implementation can be used.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes a first syntax element that indicates whether a non-linear function-based prediction method is applied to process a current block based on a template matching prediction. The non-linear function-based prediction method applies a prediction model that is associated with a template type of a template of the current block and includes a non-linear function that is applied to a reference block of the current block. The non-linear function includes parameters derived based on the template of the current block and a template of the reference block. The format rule specifies that, when the first syntax element indicates that the non-linear function-based prediction method is applied to the current block, a plurality of template matching (TM) costs between the template of the current block and the template of the reference block is determined according to a plurality of candidate prediction models associated with the non-linear function-based prediction method. The format rule specifies that the prediction model is determined from the plurality of candidate prediction models based on the plurality of TM costs. For example, the prediction model corresponds to a selected TM cost of the plurality of TM costs. The format rule specifies that the non-linear function of the prediction model is applied to process samples of the reference block. The format rule specifies that a prediction block of the current block is determined as the reference block processed by the non-linear function of the prediction model.

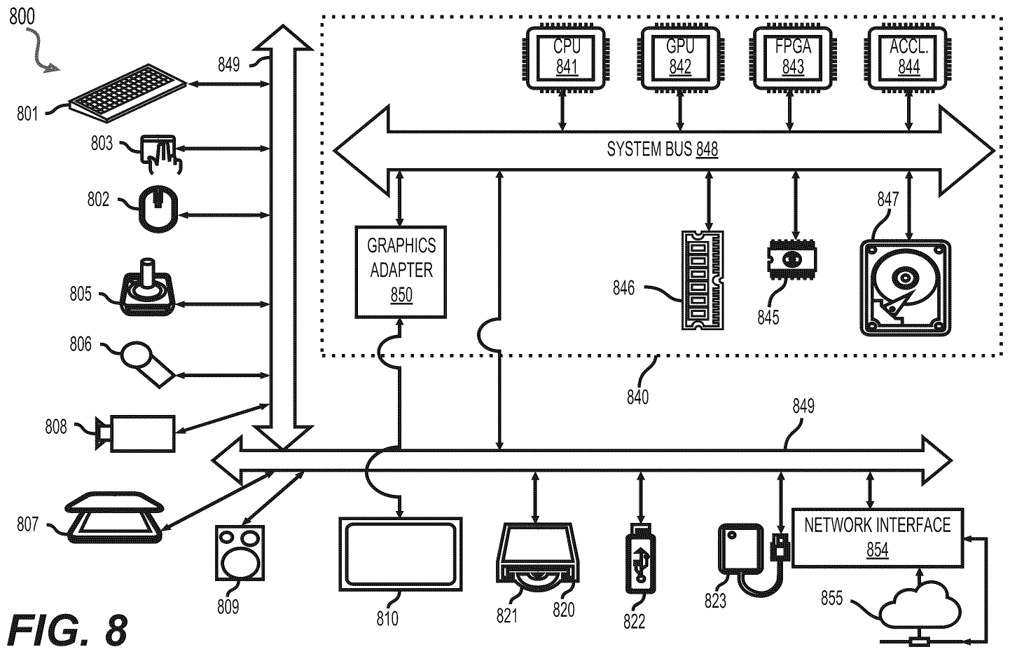

The techniques described above, can be implemented as computer software using computer-readable instructions and physically stored in one or more computer-readable media. For example, FIG. 8 shows a computer system (800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system (800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (800).

Computer system (800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (801), mouse (802), trackpad (803), touch screen (810), data-glove (not shown), joystick (805), microphone (806), scanner (807), camera (808).

Computer system (800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (810), data-glove (not shown), or joystick (805), but there can also be tactile feedback devices that do not serve as input devices), audio output devices (such as: speakers (809), headphones (not depicted)), visual output devices (such as screens (810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (800) can also include human accessible storage devices and their associated media such as optical media including CD/DVD ROM/RW (820) with CD/DVD or the like media (821), thumb-drive (822), removable hard drive or solid state drive (823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (800) can also include an interface (854) to one or more communication networks (855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (849) (such as, for example USB ports of the computer system (800)); others are commonly integrated into the core of the computer system (800) by attachment to a system bus as described below (for example Ethernet interface into a PC computer system or cellular network interface into a smartphone computer system). Using any of these networks, computer system (800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (840) of the computer system (800).

The core (840) can include one or more Central Processing Units (CPU) (841), Graphics Processing Units (GPU) (842), specialized programmable processing units in the form of Field Programmable Gate Areas (FPGA) (843), hardware accelerators for certain tasks (844), graphics adapters (850), and so forth. These devices, along with Read-only memory (ROM) (845), Random-access memory (846), internal mass storage such as internal non-user accessible hard drives, SSDs, and the like (847), may be connected through a system bus (848). In some computer systems, the system bus (848) can be accessible in the form of one or more physical plugs to enable extensions by additional CPUs, GPU, and the like. The peripheral devices can be attached either directly to the core's system bus (848), or through a peripheral bus (849). In an example, the screen (810) can be connected to the graphics adapter (850). Architectures for a peripheral bus include PCI, USB, and the like.

CPUs (841), GPUs (842), FPGAs (843), and accelerators (844) can execute certain instructions that, in combination, can make up the aforementioned computer code. That computer code can be stored in ROM (845) or RAM (846). Transitional data can also be stored in RAM (846), whereas permanent data can be stored for example, in the internal mass storage (847). Fast storage and retrieve to any of the memory devices can be enabled through the use of cache memory, that can be closely associated with one or more CPU (841), GPU (842), mass storage (847), ROM (845), RAM (846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (800), and specifically the core (840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (840) that are of non-transitory nature, such as core-internal mass storage (847) or ROM (845). The software implementing various aspects of the present disclosure can be stored in such devices and executed by core (840). A computer-readable medium can include one or more memory devices or chips, according to particular needs. The software can cause the core (840) and specifically the processors therein (including CPU, GPU, FPGA, and the like) to execute particular processes or particular parts of particular processes described herein, including defining data structures stored in RAM (846) and modifying such data structures according to the processes defined by the software. In addition or as an alternative, the computer system can provide functionality as a result of logic hardwired or otherwise embodied in a circuit (for example: accelerator (844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding, the method comprising:
receiving a bitstream including a first syntax element that indicates whether a function-based prediction method is applied to reconstruct a current block based on a template matching prediction, the function-based prediction method applying a prediction model that is associated with a template type of a template of the current block and includes a function that is applied to a reference block of the current block, the function including parameters derived based on the template of the current block and a template of the reference block;
when the first syntax element indicates that the function-based prediction method is applied to reconstruct the current block, determining the prediction model from a plurality of candidate prediction models based on a plurality of template matching (TM) costs between the template of the current block and the template of the reference block according to the plurality of candidate prediction models associated with the function-based prediction method; and
determining a prediction block of the current block as the reference block processed by the function of the prediction model.

2. The method of claim 1, wherein the determining the prediction model further comprises:
applying a function of each of the plurality of candidate prediction models to the template of the current block and the template of the reference block to obtain a processed template of the current block and the processed template of the reference block;
determining each of the plurality of TM costs based on the processed template of the current block and the processed template of the reference block according to a respective one of the plurality of candidate prediction models; and
determining the prediction model from the plurality of candidate prediction models that corresponds to a minimum TM cost of the plurality of TM costs.

3. The method of claim 1, wherein the determining the prediction block of the current block further comprises:
applying the function of the prediction model to process samples of the reference block; and
determining the prediction block of the current block as the samples of the reference block processed by the function of the prediction model.

4. The method of claim 1, wherein:
the function is one of a linear function and a non-linear function, and
the linear function is defined as
$${\sum }_{i = 0}^{n} ( {α}_{i} \times p ( {x}_{i} , {y}_{i} ) ) ,$$
p(xᵢ,yᵢ) being a sample of the reference block, αᵢ and β being factors.

5. The method of claim 1, wherein the template type includes one of:
a first template type that includes a first template region positioned at a left side of the current block,
a second template type that includes a second template region positioned at a top side of the current block,
a third template type including the first template region positioned at the left side of the current block and the second template region positioned at the top side of the current block, and
a fourth temple type including the first template region positioned at the left side of the current block, the second template region positioned at the top side of the current block, and a top-left template region positioned at a top-left corner of the current block and arranged between the first template region and the second template region.

6. The method of claim 1, wherein the first syntax element indicates that the prediction model is applied to at least one of a Cb component and a Cr component of the current block.

7. The method of claim 1, wherein the determining the prediction model comprises:
generating processed samples of the template of the current block and processed samples of the template of the reference block based on a first candidate prediction model of the plurality of candidate prediction models;
determining a first TM cost of the plurality of TM costs based on the processed samples of the template of the current block and the processed samples of the template of the reference block;
filtering the samples of the template of the current block and the samples of the template of the reference block;
generating processed filtered samples of the template of the current block and processed filtered samples of the template of the current block based on the first candidate prediction model; and
determining a second TM cost of the plurality of TM costs based on the processed filtered samples of the template of the current block and the processed filtered samples of the template of the reference block.

8. The method of claim 7, wherein the filtering further comprises:
subtracting a mean of samples of the template of the current block from each of the samples of the template of the current block to generate adjusted samples of the template of the current block;
subtracting a mean of samples of the template of the reference block from each of the samples of the template of the reference block to generated adjust samples of the template of the current block; and
determining a third TM cost of the plurality of TM costs based on the adjusted samples of the template of the current block and the adjusted samples of the template of the reference block.

9. The method of claim 1, wherein the determining the prediction model comprises:
determining a first TM cost of the plurality of TM costs based on samples of the template of the current block and samples of the template of the reference block;
generating processed samples of the template of the current block and processed samples of the template of the reference block based on a first candidate prediction model of the plurality of candidate prediction models; and
determining a second TM cost of the plurality of TM costs based on the processed samples of the template of the current block and the processed samples of the template of the reference block.

10. The method of claim 1, wherein the determining the prediction block of the current block further comprises:
determining one of the plurality of TM costs that is indicated by a second syntax element in the bitstream;
determining the prediction model from the plurality of candidate prediction models that corresponds to the determined one of the plurality of TM costs;
applying the function of the prediction model to process samples of the reference block; and
determining the prediction block of the current block based on the samples of the reference block that are processed by the function of the prediction model.

11. The method of claim 2, further comprising:
normalizing each TM cost of the plurality of TM costs by dividing the respective TM cost with a template size corresponding to the respective TM cost;
reordering the plurality of normalized TM costs in an ascending order based on the normalized TM costs; and
generating a candidate list based on the plurality of reordered normalized TM costs.

12. The method of claim 11, further comprising:
receiving a third syntax element in the bitstream that indicates which one of the plurality of reordered normalized TM costs is selected, the third syntax element being associated with at least one of a Cb component or a Cr component of the current block; and
determining the prediction model from the plurality of candidate prediction models that corresponds to the TM cost indicated by the third syntax element.

13. A method of video encoding, the method comprising:
determining whether a function-based prediction method is applied to predict a current block based on a template matching prediction, the function-based prediction method applying a prediction model that is associated with a template type of a template of the current block and includes a function that is applied to a reference block of the current block, the function including parameters derived based on the template of the current block and a template of the reference block;
when the function-based prediction method is determined to be applied to predict the current block, determining the prediction model from a plurality of candidate prediction models based on a plurality of template matching (TM) costs between the template of the current block and the template of the reference block according to the plurality of candidate prediction models associated with the function-based prediction method; and
determining a prediction block of the current block as the reference block processed by the function of the prediction model.

14. The method of claim 13, wherein the determining the prediction model further comprises:
applying a function of each of the plurality of candidate prediction models to the template of the current block and the template of the reference block to obtain a processed template of the current block and the processed template of the reference block;
determining each of the plurality of TM costs based on the processed template of the current block and the processed template of the reference block according to a respective one of the plurality of candidate prediction models; and
determining the prediction model from the plurality of candidate prediction models that corresponds to a minimum TM cost of the plurality of TM costs.

15. The method of claim 13, wherein the determining the prediction block of the current block further comprises:
applying the function of the prediction model to process samples of the reference block; and
determining the prediction block of the current block as the samples of the reference block processed by the function of the prediction model.

16. The method of claim 13, wherein:
the function is one of a linear function and a non-linear function, and
the linear function is defined as
$${\sum }_{i = 0}^{n} ( {α}_{i} \times p ( {x}_{i} , {y}_{i} ) ) ,$$
p(xᵢ,yᵢ) being a sample of the reference block, αᵢ and β being factors.

17. The method of claim 13, wherein the template type includes one of:
a first template type that includes a first template region positioned at a left side of the current block,
a second template type that includes a second template region positioned at a top side of the current block,
a third template type including the first template region positioned at the left side of the current block and the second template region positioned at the top side of the current block, and
a fourth temple type including the first template region positioned at the left side of the current block, the second template region positioned at the top side of the current block, and a top-left template region positioned at a top-left corner of the current block and arranged between the first template region and the second template region.

18. The method of claim 13, further comprising:
encoding a first syntax element into a bitstream to indicate that the prediction model is applied to at least one of a Cb component and a Cr component of the current block.

19. The method of claim 13, wherein the determining the prediction model comprises:
generating processed samples of the template of the current block and processed samples of the template of the reference block based on a first candidate prediction model of the plurality of candidate prediction models;
determining a first TM cost of the plurality of TM costs based on the processed samples of the template of the current block and the processed samples of the template of the reference block;
filtering the samples of the template of the current block and the samples of the template of the reference block;
generating processed filtered samples of the template of the current block and processed filtered samples of the template of the current block based on the first candidate prediction model; and
determining a second TM cost of the plurality of TM costs based on the processed filtered samples of the template of the current block and the processed filtered samples of the template of the reference block.

20. A non-transitory computer readable medium storing a video media bitstream encoded by an encoding method, the encoding method comprising:
determining whether a function-based prediction method is applied to predict a current block based on a template matching prediction, the function-based prediction method applying a prediction model that is associated with a template type of a template of the current block and includes a function that is applied to a reference block of the current block, the function including parameters derived based on the template of the current block and a template of the reference block;
when the function-based prediction method is determined to be applied to predict the current block, determining the prediction model from a plurality of candidate prediction models based on a plurality of template matching (TM) costs between the template of the current block and the template of the reference block according to the plurality of candidate prediction models associated with the function-based prediction method;
determining a prediction block of the current block as the reference block processed by the function of the prediction model; and
encoding the current block into the video media bitstream based on the determined prediction block of the current block.
